(19) United States
(12) Patent Application Publication
(10) Pub. No.: US 2008/0059251 A1
(43) Pub. Date: Mar. 6, 2008

(54) Healthcare benefit management system and method

(76) Inventor: James Biorge, Fruit Heights, UT (US)

Correspondence Address: John R. Thompson;STOEL RIVES LLP, One Utah Center, 201 South Main Street, Suite 1100, Salt Lake City, UT, 84111, US

(21) Appl. No.: 11/512,493

(22) Filed: Aug. 30, 2006

(51) Int. Cl. G06Q 10/00; G06Q 40/00

(52) U.S. Cl. 705/4; 705/2; 705/1

(57) ABSTRACT

A system for managing a healthcare benefits plan based upon estimated or actual employee healthcare expenses including an employer computer, a processing center, and an issuing bank in communication with one another via a network. The employer computer includes an enrollment module configured to enable a plurality of employees to enter preventive and medical expenses incurred or to be incurred by themselves and their dependents as part of enrolling in the healthcare benefits plan. The processing center includes an accounting and reporting module configured to generate periodic statements regarding the usage of the healthcare benefits plan. The issuing bank is configured to establish a plurality of healthcare benefit accounts on behalf of the employees and to issue a healthcare benefit card to each employee. The employer computer has a benefit management module configured to establish and/or monitor the performance of the healthcare benefits plan and to adjust the contributions made to the insurance premiums and healthcare benefit plans based on the employee expenses as entered in the enrollment process or from periodic statements generated by the accounting and reporting module of the processing center.

### TECHNICAL FIELD

This application relates generally to the medical health benefits industry and, more particularly, to selecting benefits programs and allocating contribution amounts paid by employees and employers in connection with such programs.

### BACKGROUND

The rising costs of health care in the 1900's became more than an individual could afford, motivating many employers to contribute to the expenses of providing medical care for employees and their families. In 1954, the Congress of the United States began passing rules that would allow companies to contribute to these medical expenses with pre-tax dollars. As health care expenses increased, large medical expenses for a serious illness or injury became too great for small businesses to afford, opening the market for insurance companies to combine groups of companies or employees to offset the costs of the few. Gradually, more specific plans evolved to meet the needs of different groups with different tax benefits and coverage plans.

Determining the best plan for a group is frequently based upon insurance agent advice and the employer evaluating what coverage would best meet the budget or amount of money the employer can afford. A similar process is used to determine the amount paid by the employer and the employee with the employer attempting to pay as much as possible. Employees accordingly feel little or no responsibility for medical expenses. Recent years have seen medical costs and resulting premium expenses rise so high that many employers are charging employees more for medical premiums. At the same time, benefit coverage has decreased, requiring employees to contribute more in the form of deductibles and co-pays for medical care with very little, if any, coverage for wellness. Many employers are unable to afford insurance at all, leaving more than 50 million employees with no medical coverage.

In order to help individuals meet these rising expenses, Congress has enabled individuals to set aside money in a Flex Spending Arrangement or Health Savings Arrangement in addition to the employer reimbursement programs, to pay for these expenses with pre-tax dollars. Despite these efforts, however, employers and employees are often confused about what plans would work best for them so that they are not taking advantage of the available programs, health care costs have continued to rise in recent years, and many existing poorly managed healthcare benefit plans are not adequately addressing these rising costs. In order to properly manage a healthcare plan, the preventive and medical expenses of individual employees must be identified and the benefit programs and contributions should be tailored to meet those needs.

### SUMMARY

The above-mentioned drawbacks associated with existing healthcare benefit management systems are addressed by embodiments of the present application, which provides additional tools for employers to identify employee health and medical needs and tailor benefit programs to better meet those needs instead of just monetary policies of the employer. The method for basing employee benefit programs on employee needs verses corporate policies will be understood by reading and studying the following specification.

In one embodiment, a system for managing a healthcare benefits plan based upon employee expenses and needs comprises an employee program that identifies, totals and or estimates employee expenses in communication with an employer computer and network, comprising enrollment modules configured to enable a plurality of employees with varying expenses to enroll in the healthcare benefit programs, using the employee expenses or estimates to determine the contributions and amounts of the benefit programs and periodically updating programs and contributions based upon the changing needs of employees. The system further comprises a processing center in communication with the network, the processing center comprising an accounting and reporting module configured to generate periodic statements regarding the usage of the healthcare benefits plan used for updating benefit programs. The system further comprises an issuing bank in communication with the network, the issuing bank being configured to establish a plurality of healthcare benefit accounts on behalf of the employees and to issue a healthcare benefit card to each employee. The employer computer comprises a benefit management module configured to monitor the performance of the healthcare benefits plan and adjust the contributions made to the healthcare benefits plan based on the periodic statements that identify the employee needs generated by the accounting and reporting module of the processing center.

In another embodiment, a method for managing a plurality of healthcare benefit plans comprises enabling a plurality of employees to enroll in the healthcare benefits plan, the plan comprising a plurality of healthcare benefit accounts tailored to the needs of the employees and facilitated by a healthcare benefit cards issued to enrolled employees. The method further comprises periodically depositing money into the healthcare benefit accounts, receiving periodic statements regarding the usage of the healthcare benefit accounts, and adjusting the amount of money deposited into the healthcare benefit accounts based on the usage activity reported in the periodic statements.

In another embodiment, a computer readable medium has stored thereon computer executable instructions for performing a method for managing a healthcare benefits plan. The method comprises enabling a plurality of employees to enroll in the healthcare benefits plan, the plan comprising a plurality of healthcare benefit accounts tailored to the expenses and needs of the employees with an associated healthcare benefit card issued to enrolled employees. The method further comprises periodically depositing money into the healthcare benefit accounts, receiving periodic statements regarding the usage of the healthcare benefit accounts, adjusting the healthcare benefits and the amount of money deposited into the healthcare benefit accounts based on the usage activity reported in the periodic statements.

In another embodiment, a computer readable medium has stored thereon computer executable instructions for performing a method for managing a plurality of employer healthcare benefits plans. The method comprises establishing a unique account for each participating employer having an employer healthcare benefits plan and transmitting information to an issuing bank for establishing benefit card accounts for each employee participating in the employer healthcare benefits plans. The method further comprises transmitting information to each participating employer for payroll adjustments associated with the benefit card accounts and preparing periodic reports providing information regarding the ongoing usage of the benefit card accounts by the employees based on transaction data received from the issuing bank. Adjustments are made to the employer healthcare benefits plans based on the ongoing usage activity included in the periodic reports.

### BRIEF DESCRIPTION OF THE DRAWINGS

Like reference numbers and designations in the various drawings indicate like elements.

FIG. 1 is a block diagram of one embodiment of a healthcare benefit management system.

FIG. 2 is a flow chart illustrating the operation of an enrollment module.

FIG. 3 is a flow chart illustrating the operation of a benefit management module.

FIG. 4 is a flow chart illustrating the operation of an accounting and reporting module.

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

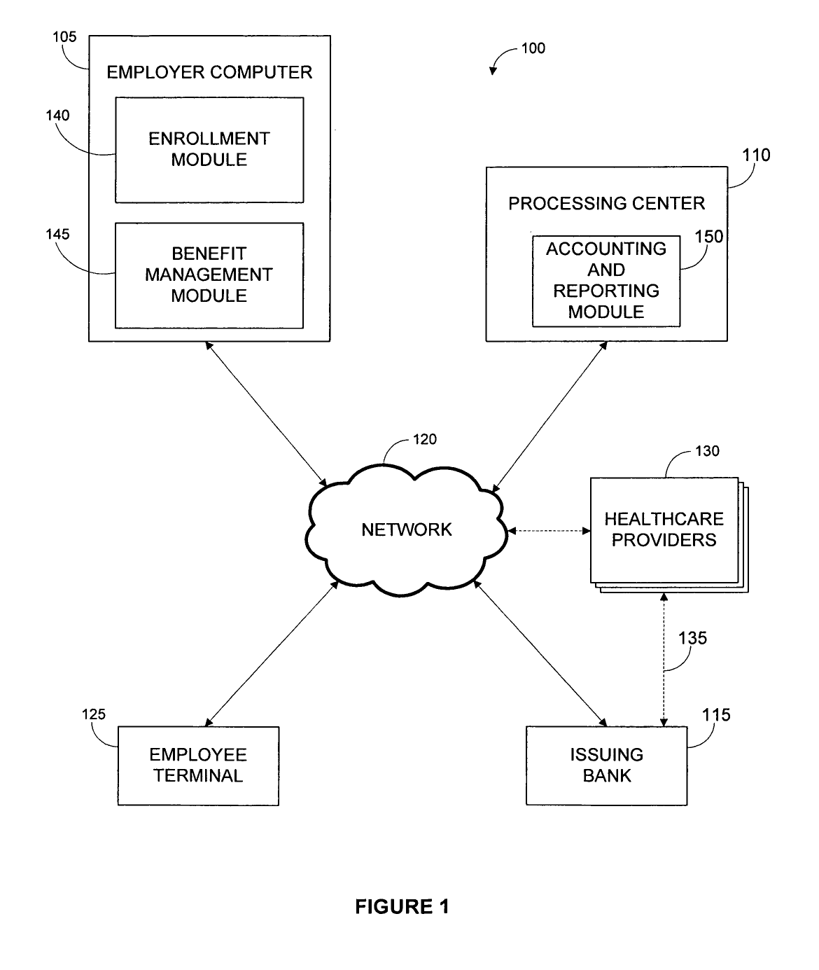

FIG. 1 is a block diagram of one exemplary embodiment of a healthcare benefit management system 100. In the illustrated embodiment, the system 100 comprises an employer computer 105, a processing center 110, and an issuing bank 115 in communication with one another via a network 120, such as the Internet, a LAN, a WAN, etc. The system 100 further comprises an optional employee terminal 125, which may comprise any device capable of accessing the employer computer directly or through the network 120, such as, for example, a desktop computer, laptop computer, PDA, cell phone, etc. The system 100 also comprises plurality of healthcare providers 130, such as insurance companies, hospitals, physicians, pharmacies, medical equipment suppliers, etc., in communication with the issuing bank 115 either via a direct communication link 135 or via the network 120.

The employer computer 105 comprises an enrollment module 140 and a benefit management module 145, which enable an employer to manage the distribution of healthcare benefits to its employees, as described in more detail below. As used herein, the term “module” may refer to any combination of software, firmware, or hardware used to perform the specified function or functions. It is contemplated that the functions performed by the modules described herein may be embodied within either a greater or lesser number of modules than is described in the accompanying text. For instance, a single function may be carried out through the operation of multiple modules, or more than one function may be performed by the same module. Additionally, the described modules may be entirely resident on a computer readable medium or dispersed throughout a plurality of computer readable mediums in the healthcare benefit management system 100.

The processing center 10 comprises an accounting and reporting module 150, which enables a system administrator to monitor the performance of benefits distribution programs and to assist participating employers in improving the performance of such programs. In operation, the processing center 110 gathers preventive and medical expense data from individual employees and captures information regarding existing employer benefit programs. This information is utilized to formulate an improved benefit plan for the employer, including payroll adjustment recommendations to meet the needs of individual employees. The processing center 110 receives and transmits enrollment, transaction, expense verification, etc. data regarding the issuing and management of the benefit plan to the issuing bank, employer, healthcare providers, etc. 115, who in turn issues or adjusts bank cards, accounts and programs that can be used by the employees to pay for qualified healthcare expenses, such as payments for doctor visits, medications, medical equipment, etc. The processing center 110 may communicate directly with the Healthcare Providers 130 and the Issuing Bank 115. Alternatively, the processing center 110 may communicate through the network 120.

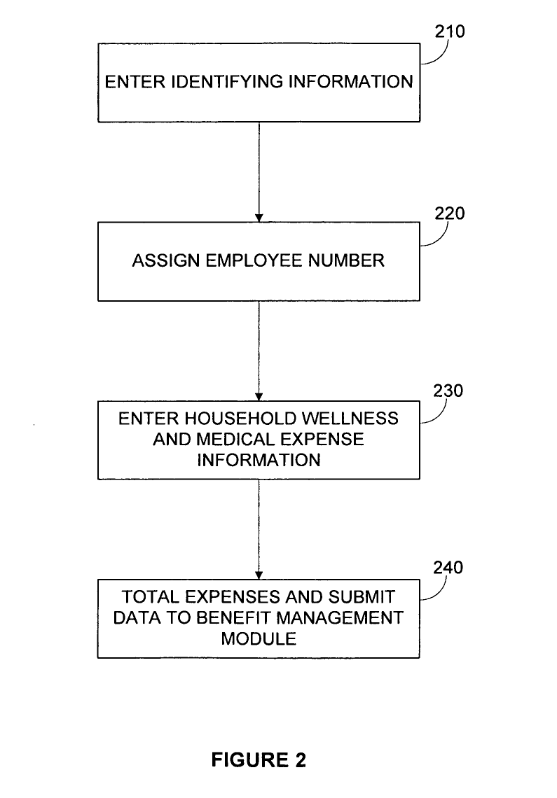

FIG. 2 is a flow chart illustrating the operation of the enrollment module 140. At a first block 210, an employee enters identifying information (e.g., name, social security number, etc.) into the enrollment module 140. In some embodiments, the employee inputs this information at the employer computer 105; in other embodiments, the employee uses the employee terminal 125 to access the enrollment module 140 remotely via the network 120.

At block 220, a unique employee number is assigned to the employee. At block 230, the employee is prompted to enter historical and anticipated future expense data regarding preventive and medical expenses in a number of qualifying categories for all in their household. In some embodiments, this process is facilitated through the use of an employee analysis program or worksheet, such as the exemplary worksheet illustrated in Table 1, below.

TABLE 1

| AMOUNT | DESCRIPTION |
|---|---|
| | Acupressure |
| | Acupuncture |
| | Aerobics |
| | Allergies |
| | Ambulance - Air or Ground |
| | Automobile Modification |
| | Back Treatments |
| | Birth Control |
| | Breathing Aids |
| | CAT Scans |
| | Chemotherapy |
| | Child Birth |
| | Christian Science Treatment |
| | Clothing Due to Prescribed Regimen |
| | Counseling |
| | Crisis Intervention |
| | Custodial Care for Medical Condition |
| | Dental Care |
| | Dental Visits |
| | Diagnostic Services |
| | Diets |
| | Disability or Medical Condition |
| | Electrical Impulse Therapy |
| | Electrolysis |
| | Emergency Medical Alert Devices |
| | Emergency Room Visits |
| | Exercise Equipment |
| | Family Counseling |
| | Fees |
| | Foot Care |
| | Guide Animals & Upkeep |
| | Hair |
| | Halfway House |
| | Health Club |
| | Hearing |
| | Heat Therapy |
| | Home Health Care |
| | Home Modification for Medical Reasons |
| | Homeopaths |
| | Hospice Care |
| | Hospitalizations |
| | Hypnotherapy |
| | Infertility |
| | Infrared Therapy |
| | Insurance |
| | Ionic Therapy |
| | Kinesiology |
| | Lab Fees |
| | Laetrile |
| | Learning Assistance Due to a |
| | Living Assistance - Medically Necessary |
| | Magnetic Therapy |
| | Massage Therapy |
| | Medical Alert Bracelet |
| | Medical Doctors |
| | Medical Equipment |
| | Medical Information Cards |
| | Medical Information Plans |
| | Medical Office Visits |
| | Medical Supplies |
| | Meditation Therapy |
| | Menopausal Therapies |
| | Mental & Nervous Disorders |
| | Musical Instruments & Lessons for Malocclusions |
| | Natural Remedies |
| | Naturopaths |
| | Ophthalmologist |
| | Optician |
| | Optometrist |
| | Osteopaths |
| | Pain Medications |
| | Patterning Exercise for Handicapped |
| | Physical Therapy |
| | Prescribed Drugs & Medical Supplies |
| | Prosthetics |
| | Psychiatric Facility |
| | Psychiatry |
| | Psychologist |
| | Psychotherapy |
| | Radiation Therapy |
| | Reading Assistance |
| | Reconstructive Surgery |
| | Rehabilitation |
| | Relaxation Therapy |
| | Repair Care |
| | Respiratory Therapy |
| | Rest Home |
| | Retirement Home |
| | Retirement Home —Prepaid |
| | Running |
| | Sanitarium |
| | School-Special Due to Handicap |
| | Sexual Dysfunction |
| | Smoking Cessation |
| | Sonic Therapy |
| | Sonograms |
| | Speaking Assistance |
| | Sports Medicine |
| | Sterilization |
| | Swimming Pool/Spa for Treatment |
| | Taxi Fare to Obtain Health Care |
| | Therapeutic Touch |
| | Therapy |
| | Thyroid Treatment |
| | Traction |
| | Transplants & Donor's Cost |
| | Travel Necessary for Medical Care |
| | Tuition |
| | Urgent Care Visits |
| | Vibration Therapy |
| | Vision |
| | Vitamins |
| | Weight Loss |
| | Wellness |
| | Wig Due to Disease |
| | X-Rays |

At block 240, the enrollment module 140 totals the expenses entered by the employee and submits the data to the benefit management module 145.

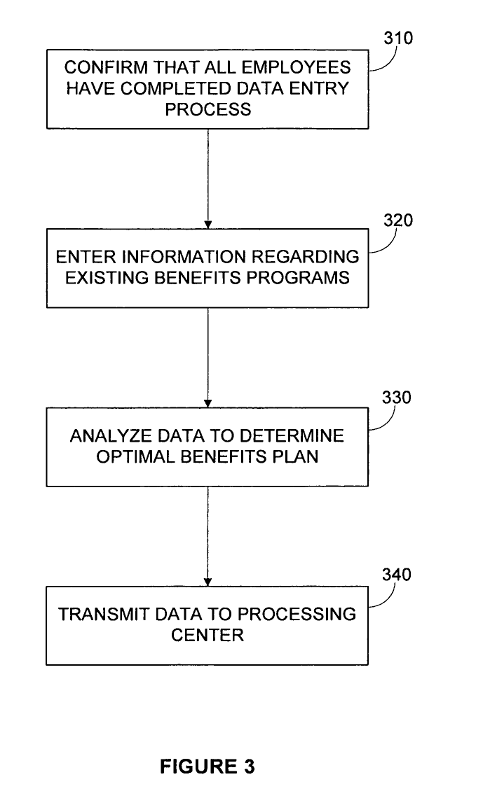

FIG. 3 is a flow chart illustrating the operation of the benefit management module 145. At block 310, the employer confirms that all eligible employees have completed the data entry process. At block 320, the employer enters information regarding existing benefits programs (e.g., total employee healthcare expenses, tax percentages, insurance plan premiums, etc.). In some embodiments, this process is facilitated through the use of an employer analysis worksheet.

At block 330, the benefit management module 145 analyzes the data submitted by the employees and the employer to determine the optimal benefit plans for the employer. In many cases, the optimal benefit plans will include some combination of employer contributions to insurance premiums and Medical Expense Reimbursement Plans and employee contributions to 125 Cafeteria Plans including Premium Only Plans and Flex Spending Account or a Health Savings Account as needed. In these cases, the benefit management module 145 advantageously determines the optimum combination of contributions from the employer and the employee to improve the coverage provided to individual employees. At block 340, the data regarding the optimal benefits plan is transmitted to the processing center 110.

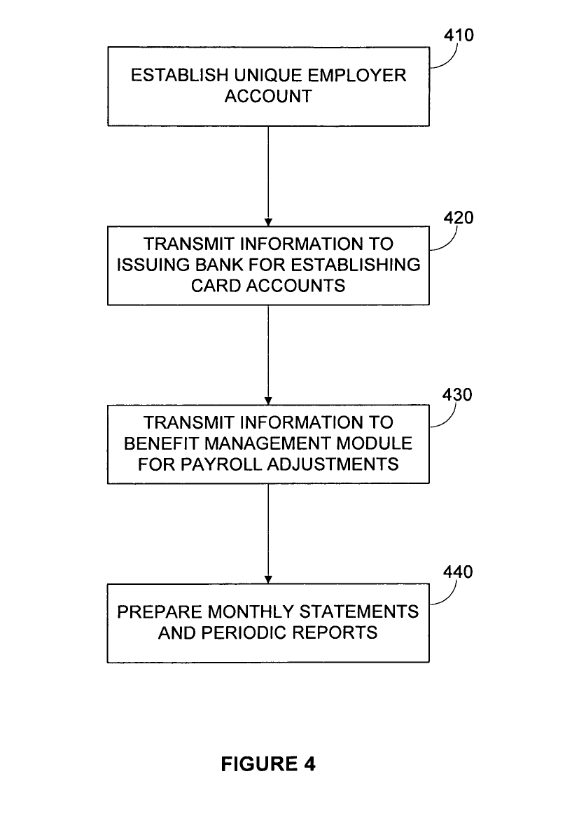

FIG. 4 is a flow chart illustrating the operation of the accounting and reporting module 150. At block 410, the system administrator establishes a unique account for each participating employer. At block 420, the processing center 110 transmits information to the issuing bank 115 to enable the issuing bank 115 to establish benefit card accounts for each participating employee. Once the benefit card accounts have been established, the issuing bank 115 issues benefit cards to the individual employees, who can use the cards to pay for qualified healthcare expenses at various healthcare providers 130, such as hospitals, physicians' offices, pharmacies, etc. These payments can advantageously be processed by the healthcare providers 130 and the issuing bank 115 using conventional, well-known techniques applicable to standard debit card or credit card transactions.

At block 430, information is transmitted to the benefit management module 145 for payroll adjustments necessary for implementation of the benefit card accounts for each employee. Using this information, the employer periodically (e.g., monthly) allocates or deposits money into the benefit card account for the use by each employee as determined and governed by the benefit programs. As described above, the amount deposited into any given benefit card account can vary widely, depending on the circumstances of the individual employee.

At block 440, the accounting and reporting module 150 prepares monthly statements and periodic reports (e.g., monthly, quarterly or annually) for the employer. These statements and reports provide information regarding the ongoing usage of the benefit card accounts by the employees based on transaction data received from the issuing bank 115. The statements and reports can be used to detect abuse, as well as to monitor the overall performance of the employer benefit plan. Current expenses may be entered in the benefit management module 145 to determine if changes are needed to maintain optimum benefit utilization. Therefore, the employer can advantageously make appropriate adjustments to the benefits plan based on actual usage of the benefit card accounts, rather than imprecise estimates of historical information. This can dramatically improve the efficiency of the benefits plan, because decisions based on current usage activity are often far more accurate than estimates based on historical information.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A system for managing and customizing healthcare benefits plan comprising:
an employer computer in communication with a network, the employer computer comprising an employee enrollment module configured to enable a plurality of employees to enter and estimate employee preventive expenses and medical expenses and to enroll and optimize employee enrollment in the healthcare benefits plan;
a processing center in communication with the network, the processing center comprising an accounting and reporting module configured to generate periodic statements regarding the usage of the healthcare benefits plan ; and
an issuing bank in communication with the network, the issuing bank configured to establish a plurality of healthcare benefit accounts on behalf of the employees and to issue a healthcare benefit card to each employee,
wherein the employer computer comprises a benefit management module configured to monitor the performance of the healthcare benefits plan and adjust the contributions made to the healthcare benefits plan based on the periodic statements generated by the accounting and reporting module of the processing center to thereby customize the health care benefits plan for each employee based on usage.

2. The system of claim 1, wherein an employee healthcare benefit card deposits and available funds are adjusted periodically to maintain optimum benefit utilization for the purchase of qualified healthcare expenses from a plurality of healthcare providers.

3. The system of claim 2, wherein the plurality of healthcare providers comprises one or more hospitals, physicians, pharmacies, or medical equipment suppliers.

4. The system of claim 1, wherein the healthcare benefits plan comprises a combination of employer contributions to reimbursement accounts and premiums, and employee contributions to a premiums, Flex Spending Account or a Health Savings Account.

5. The system of claim 1, further comprising an employee terminal configured to access the enrollment module of the employer computer remotely via the network, the employee terminal configured to estimate or enable employee entering of preventive expenses and medical expenses.

6. A method for managing a healthcare benefits plan based upon employee preventive and medical expenses, comprising:
enabling a plurality of employees to enroll in the healthcare benefits plan, the healthcare benefits plan comprising a plurality of healthcare benefit accounts with associated healthcare benefit cards issued to enrolled employees;
periodically depositing money into the healthcare benefit accounts,
receiving periodic statements regarding the usage of the healthcare benefit accounts; and
adjusting the amount of money deposited into the healthcare benefit accounts based on the employee usage activity reported in the periodic statements to thereby customize the healthcare benefits plan for each employee based on usage.

7. The method of claim 6, wherein an employee can use the same healthcare benefit card after periodic optimization for qualified healthcare expenses from a plurality of healthcare providers.

8. The method of claim 7, wherein the plurality of healthcare providers comprises one or more hospitals, physicians, pharmacies, or medical equipment suppliers.

9. The method of claim 6, wherein the healthcare benefits plan comprises a combination of employer contributions and employee contributions to insurance premiums, medical expense reimbursement, Flex Spending Account or a Health Savings Account tailored to preventive and medical expenses of employees.

10. The method of claim 6, wherein enabling the plurality of employees to enroll in the healthcare benefits plan comprises enabling the employees to access an enrollment module remotely.

11. The method of claim 6, wherein enabling the plurality of employees to enroll in the healthcare benefits plan comprises gathering preventive expense and medical expense data from the employees.

12. A computer readable medium having stored thereon computer executable instructions for performing a method for customizing and managing a healthcare benefits plan, the method comprising:
enabling a plurality of employees with a variety of medical expenses and needs to enroll in the healthcare benefits plan, the healthcare benefits plan comprising a plurality of healthcare benefit accounts with associated healthcare benefit cards issued to enrolled employees;
periodically depositing money into the healthcare benefit accounts,
receiving periodic statements regarding the usage of the healthcare benefit accounts; and
adjusting the amount of money deposited into the healthcare benefit accounts based on the usage activity reported in the periodic statements to thereby customize the healthcare benefits plan for each employee based on usage.

13. The computer readable medium of claim 12, wherein an employee can use a healthcare benefit card for qualified healthcare expenses from a plurality of healthcare providers.

14. The computer readable medium of claim 13, wherein the plurality of healthcare providers comprises one or more hospitals, physicians, pharmacies, or medical equipment suppliers.

15. The computer readable medium of claim 12, wherein the healthcare benefits plan comprises a combination of employer contributions and employee contributions to a Flex Spending Account or a Health Savings Account.

16. The computer readable medium of claim 12, wherein enabling the plurality of employees to enroll in the healthcare benefits plan comprises enabling the employees to access an enrollment module remotely.

17. The computer readable medium of claim 12, wherein enabling the plurality of employees to enroll in the healthcare benefits plan comprises gathering preventive expense and medical expense data from the employees.

18. A computer readable medium having stored thereon computer executable instructions for performing a method for managing a plurality of employer healthcare benefits plans, the method comprising:
establishing a unique account for each participating employer having an employer healthcare benefits plan;
transmitting information to an issuing bank for establishing benefit card accounts for each employee participating in the employer healthcare benefits plans;
transmitting information to each participating employer for payroll adjustments associated with the benefit card accounts; and
preparing periodic reports providing information regarding the ongoing usage of the benefit card accounts by the employees based on transaction data received from the issuing bank,
wherein adjustments are made to the employer healthcare benefits plans based on the ongoing usage activity included in the periodic reports.

19. The computer readable medium of claim 18, wherein the periodic reports are used to detect abuse of the employer healthcare benefits plans.

20. The computer readable medium of claim 18, wherein the employer healthcare benefits plans comprise a combination of employer contributions and employee contributions to a Flex Spending Account or a Health Savings Account.
